(19) United States
(12) Patent Application Publication
(10) Pub. No.: US 2007/0081730 A1
(43) Pub. Date: Apr. 12, 2007

(54) Image encoding apparatus and image decoding apparatus

(76) Inventors: Kenji Arakawa, Kyoto (JP); Toshinobu Hatano, Kyoto (JP)

Correspondence Address: MCDERMOTT WILL & EMERY LLP, 600 13TH STREET, N.W., WASHINGTON, DC, 20005-3096, US

(21) Appl. No.: 11/542,135

(22) Filed: Oct. 4, 2006

(30) Foreign Application Priority Data
Oct. 7, 2005 (JP) 2005-294385

(51) Int. Cl. G06K 9/36

(52) U.S. Cl. 382/232

(57) ABSTRACT

An image encoding apparatus according to the present invention comprises a conversion table for recording therein a rearrangement rule for the encoded data where the encoded data is divided into a plurality of data and a restart marker is intervened between the adjacent divided data, an encoder for generating the encoded data by encoding image data based on the JPEG method using the restart marker, and a scramble converter for dividing the encoded data outputted from the encoder into the plurality of data using the restart marker and rearranging the divided data based on the rearrangement rule recorded in the conversion table.

### BACKGROUND OF THE INVENTION

1. Field of the Invention

The present invention relates to an image encoding apparatus, an image decoding apparatus, an image encoding method and an image decoding method, more specifically to a technology for applying a scramble processing to encoded data which is encoded based on the JPEG method (Joint Photographic Coding Experts Group).

2. Description of the Related Art

In a conventional manner of data-transmission of a still image, image data is randomly accessed per macro block and compressed (encoded), and the compressed data (encoded data) is transmitted. In relation to the transmission of the still image, No. H08-9359 of the Japanese Patent Applications Laid-Open recites a technology wherein control data comprising presence or absence of scrambling and coordinate table that is generated randomly, is previously transferred from inside communication commands on the transmission (compression) side and then, judgment is made on presence or absence of scrambling based on the transferred control data on the reception (extension) side. If judgment result shows scrambling, storage addresses in an image memory for the macro block of the next still image data (compressed data) to be received are generated based on the received coordinate table.

However, it is necessary to previously transfer the control data such as the presence or absence of scrambling and the coordinate table as the command before the transfer of the compressed data in the conventional technology. Further, it is necessary to previously connect a communication line in order to realize the foregoing transfer, and additionally, to incorporate a controller for accessing the memory based on the coordinate table into a circuit. Anyone can see the descrambled image using the controller, which makes it impossible to protect the confidentiality of the image.

### SUMMARY OF THE INVENTION

Therefore, a main object of the present invention is to protect the confidentiality of an image while execution or release of scrambling, making it unnecessary to add information on whether the compressed data is scrambled or not and a coordinate table to the compressed (encoded) data. Another main object of the present invention is to achieve the foregoing object in a system without a communication line such as a digital camera.

An image encoding apparatus according to the present invention comprises:

a conversion table for recording therein a rearrangement rule in the encoded data where it is divided into a plurality of data and a restart marker is intervened between the adjacent divided data;

an encoder for generating the encoded data by encoding image data based on the JPEG method using the restart marker; and

a scramble converter for dividing the encoded data outputted from the encoder into the plurality of data using the restart marker and rearranging the divided data based on the rearrangement rule recorded in the conversion table.

According to the foregoing constitution, the image data is encoded in the form of the encoded data including the restart marker, and the data is rearranged by each restart marker and scrambled. Therefore, even though the scrambled encoded data is decoded in a conventional manner, an image reproduced from the decoded data cannot be easily confirmed, and the confidentiality of the image is thereby protected. In the present invention, it is unnecessary to add a command or the like to the encoded data, and any necessary information is embedded in the encoded data. Therefore, it apparently seems to be a structure of only the encoded data. When the restart marker is inserted by a plurality of macro blocks or a single macro block, the data is completed by a predetermined byte unit at each of restart markers, and can be thereby separated without any influence from a proximate DC component. To be brief, it is unnecessary to transfer the information on the presence or absence of scrambling and the coordinate table. Further, it becomes unnecessary to provide the controller for accessing a memory based on the coordinate table, and the present constitution is applicable to a system in which a communication line is not provided such as a digital camera.

There is a preferable mode that the encoder encodes the image data using the restart marker per n X macro block (n is a natural number), in this case it becomes more difficult to confirm the image as the number n is smaller.

There is another preferable mode that the restart marker is set so as to be made cycling every predetermined numbers, and the conversion table records therein a rule for rearranging the data put together by a pair of restart markers adjacent to each other in the cycle of an arbitrary restart marker and the data put together by a pair of restart markers located at the same cycle order as that of the pair of restart markers in the cycle of another restart marker as the rearrangement rule. According to the foregoing mode, the standards of the JPEG format are not violated even after the encoded data is scrambled as long as it is the same restart marker. As a result, the encoded data can be decoded in the conventional manner while it is more difficult to confirm the image.

There is, further, another preferable mode of the foregoing constitution that the restart marker set so as to be made cycling every predetermined numbers, and the conversion table records therein a rule for rearranging all of the data included in cycle of an arbitrary restart marker and all of the data included in cycle of another restart marker as the rearrangement rule. According to the foregoing mode, the encoded data is scrambled per n X macro block X predetermined cycle numbers of the restart markers (n is a natural number), which facilitates the preparation of the conversion table. Thereby, the standards of the JPEG format are not violated even after the encoded data is scrambled. As a result, the encoded data can be decoded in the conventional manner while it is made more difficult to confirm the image.

Furthermore, there is another preferable mode that the restart marker set so as to be made cycling every predetermined numbers, and the conversion table records therein a rule for randomly rearranging the data put together by a pair of restart markers located in order adjacent to each other in cycle of an arbitrary restart marker and the data put together by a pair of restart markers located in order adjacent to each other in cycle of another restart marker as the rearrangement rule. According to the foregoing mode, though the scrambled encoded data violates the standards of the JPEG format, it becomes difficult to decode the scrambled encoded data in the conventional manner. As a result, the confirmation of the image becomes difficult.

There is an alternate another preferable mode that the conversion table records therein a plurality of rearrangement rules, and the image encoding apparatus further comprises:

an input unit for accepting an input operation of an operator who designates a particular rule among the plurality of rearrangement rules in the conversion table; and

a display unit for displaying an image assisting the selection from the plurality of rearrangement rules. According to the foregoing mode, if the particular rearrangement rule designated by the operator in encoding the data is unknown, the confirmation of the image of the decoded data becomes difficult even though the scrambled encoded data may be decoded. As a result, the confidentiality of the image can be protected.

In addition, there is another preferable mode that the conversion table records therein a rule for alternately rearranging the data in a plurality of encoded data as the rearrangement rule. According to the foregoing mode, even if the scrambled encoded data is decoded in the conventional manner, the decoded data includes a plurality of data mixed at n X macro block (n is a natural number) unit, as a result, it makes further difficult to confirm the image.

Further, there is another preferable mode that the conversion table records therein a rule for rearranging the data constituting apart of the encoded data as the rearrangement rule. According to the foregoing mode, the image can be partly scrambled. For example, only a person whose right of portrait is not permitted can be scrambled in a group photograph.

Furthermore, there is another preferable mode that the image encoding apparatus further comprises a central unit for inserting the rearrangement rule into at least one of an APP1 marker segment and an APP2 marker segment of the encoded data. The APP1 marker segment and the APP2 marker segment store therein adjunct information and extended data of Exif, and it is not necessary to decode the encoded data. So, it is skipped in the conventional decoding operation. Therefore, the rearrangement rule of the conversion table can be inserted into the encoded data while the format of the encoded data is retained. According to this, when the scrambled encoded data is decoded, the relevant encoded data is decoded as the data which is still scrambled in the conventional decoding operation. According to this, the encoded data is decoded based on the rearrangement rule inserted therein, and the encoded data can be thereby descrambled and then decoded.

Moreover, there is another preferable mode that the scramble converter rewrites the restart markers failing to follow predetermined correct order due to the rearrangement rule so as to follow the correct order. If the order of the restart marker is incorrect after the encoded data is scrambled, the standard of the JPEG format is violated. Then, the encoded data cannot be decoded in the conventional manner. However, by rewriting the restart marker so as to follow the proper order, the data can be decoded in the conventional manner. As a result, such a wrong judgment that the encoded data may be destroyed can be prevented.

An image decoding apparatus according to the present invention comprises:

a conversion table for recording therein a rearrangement rule for the encoded data divided into a plurality of data and intervened with a restart marker between the adjacent divided data;

a scramble converter for dividing the encoded data into the plurality of data using the restart marker and rearranging the divided data based on the rearrangement rule recorded in the conversion table; and

a decoder for decoding the encoded data, in which the data is rearranged by the scramble converter, into image data based on the JPEG method using the restart marker.

According to the foregoing constitution, the encoded data encoded under including the restart markers and scrambled after the data is rearranged every restart markers can be descrambled after the data is rearranged again based on the rearrangement rule. Thereby, the scrambled encoded data, which cannot be confirmed in the conventional decoding operation, can be decoded.

According to a preferable mode of the foregoing constitution, the restart marker is set so as to be made cycling every predetermined numbers, and the conversion table records therein a rule for rearranging the data put together by a pair of restart markers adjacent to each other in cycle of an arbitrary restart marker and the data put together by a pair of restart markers located at the same order as that of the pair of restart markers in cycle of another restart marker as the rearrangement rule. According to this, the standards of the JPEG format are not violated even after the encoded data is scrambled in the case of the same restart marker. As a result, the encoded data can be decoded in the conventional manner while it is more difficult to confirm the image.

Furthermore, there is another preferable mode that the restart marker is set so as to be made cycling every predetermined numbers, and the conversion table records therein a rule for rearranging all of the data included in cycle of an arbitrary restart marker and all of the data included in cycle of another restart marker as the rearrangement rule. According to this, the encoded data is scrambled in n X macro block X predetermined numbers of the restart markers in cycling (n is a natural number), which facilitates the preparation of the conversion table. Thereby, the standards of the JPEG format are not violated even after the encoded data is scrambled. As a result, the encoded data can be decoded in the conventional manner while it is made more difficult to confirm the image.

There is also another preferable mode that the restart marker is set so as to be made cycling every predetermined numbers, and the conversion table records therein a rule for randomly rearranging the data put together by a pair of restart markers located in order adjacent to each other in cycle of an arbitrary restart marker and the data put together by a pair of restart markers located in order adjacent to each other in cycle of another restart marker as the rearrangement rule. According to this, the scrambled encoded data violates the standards of the JPEG format, and it is impossible to decode the scrambled encoded data in the conventional manner. However, in the present invention, as the encoded data can be descrambled based on the rearrangement rule of the encoded data, the image can be confirmed.

Further, there is another preferable mode that the conversion table records therein a plurality of rearrangement rules, and the image decoding apparatus further comprises an input unit for accepting an input operation of an operator who designates a particular rule among the plurality of rearrangement rules in the conversion table, and a display unit for displaying an image assisting the selection from the plurality of rearrangement rules. According to this, if the particular rearrangement rule designated by the operator in encoding the data is not correctly inputted when the encoded data is decoded, the image of the decoded data cannot be confirmed even if the scrambled encoded data is decoded. However, in the present invention, as the encoded data can be descrambled based on the rearrangement rule of the encoded data, the image can be confirmed.

Furthermore, there is another preferable mode that the conversion table records therein a rule for alternately rearranging the data in a plurality of encoded data as the rearrangement rule. According to this, even though the scrambled encoded data is decoded in the conventional manner, the decoded data includes a plurality of data mixed in n X macro block (n is a natural number) unit, and therefore the image cannot be confirmed. However, in the present invention, as the encoded data can be descrambled based on the rearrangement rule of the encoded data, the image can be confirmed.

Likewise, there is another preferable mode that the image decoding apparatus further comprises a central unit for obtaining the rearrangement rule from at least one of an APP1 marker segment and an APP2 marker segment of the encoded data and recording the obtained rearrangement rule in the conversion table. According to this, when the scrambled encoded data is decoded, the relevant encoded data is decoded as the data which is still scrambled in the conventional decoding operation. According to the foregoing mode, the encoded data can be thereby descrambled and then decoded if the encoded data is decoded based on the rearrangement rule inserted therein.

Further, there is another preferable mode that the scramble converter rewrites the restart markers failing to follow predetermined correct order due to the rearrangement rule so as to follow the correct order. According to this, if the order of the restart marker is incorrect after the encoded data is descrambled, the standards of the JPEG format are violated. Then, the encoded data cannot be decoded in the conventional manner. However, when the restart marker is rewritten so as to follow the proper order, the data can be decoded in the conventional manner. As a result, such a wrong judgment that the encoded data maybe destroyed can be prevented.

An image encoding method according to the present invention comprises:

an encoding step in which image data is encoded by means of a restart marker based on the JPEG method so that encoded data is generated; and

a scramble conversion step in which the encoded data is divided into a plurality of data by means of the restart marker and the divided data is rearranged based on a predetermined rearrangement rule.

According to this, the image data is converted into the encoded data including the restart marker, and the encoded data can be rearranged every restart markers and then scrambled. Therefore, the image cannot be confirmed when the scrambled encoded data is decoded in the conventional manner.

Moreover, there is a preferable mode that the image encoding method further includes a macro block number setting step in which number of macro blocks sandwiched by the adjacent restart markers is set in the encoded data, wherein the image data is encoded per n X macro block (n is a natural number) sandwiched by the restart markers in the encoding step. According to this, the confirmation of the image is made difficult as the number n is smaller.

There is yet another preferable mode that the restart marker is set so as to be made cycling every predetermined numbers, and rearrangement is carried out between the data put together by a pair of restart markers located at order adjacent to each other in cycle of an arbitrary restart marker and the data put together by a pair of restart markers located at the same order as that of the pair of restart markers in cycle of another restart marker in the scramble conversion step. In this case, the standards of the JPEG format are not violated even after the encoded data is scrambled in the case of the same restart marker. As a result, the encoded data can be decoded in the conventional manner while it is made more difficult to confirm the image.

There is yet another preferable mode that the restart marker is set so as to be made cycling every predetermined numbers, and rearrangement is carried out between all of the data included in cycle of an arbitrary restart marker and all of the data included in cycle of another restart marker in the scramble conversion step. According to this, the encoded data is scrambled with n X macro block X predetermined numbers of the restart markers in cycling (n is a natural number), which facilitates the preparation of the conversion table. Thereby, the standards of the JPEG format are not violated even after the encoded data is scrambled. As a result, the encoded data can be decoded in the conventional manner while it is made more difficult to confirm the image.

There is yet another preferable mode that the restart marker is set to be made cycling every predetermined numbers, and random rearrangement is carried out between the data put together by a pair of restart markers located at order adjacent to each other in cycle of an arbitrary restart marker and the data put together by a pair of restart markers located at order adjacent to each other in cycle of another restart marker in the scramble conversion step. According to this, though the scrambled encoded data violates the standards of the JPEG format, it is made difficult to decode the scrambled encoded data in the conventional manner. As a result, the confirmation of the image becomes impossible.

There is yet another preferable mode that the image encoding method further includes a designating step and a display step, wherein

an arbitrary rearrangement rule is designated from a plurality of rearrangement rules in the designating step, and

the data is rearranged based on the arbitrary rearrangement rule designated in the designating step in the scramble conversion step, and

an image assisting the selection from the plurality of rearrangement rules is displayed in the display step. According to this, if the particular rearrangement rule designated by the operator in encoding the data is not identified when the scrambled encoded data is decoded, the confirmation of the image becomes difficult. As a result, the confidentiality of the image can be more strictly protected.

There is yet another preferable mode that the data is alternately rearranged in a plurality of encoded data in the scramble conversion step. According to this, when the scrambled encoded data is decoded in the conventional manner, the decoded data includes a plurality of data mixed at n X macro block (n is a natural number) unit, which further makes it difficult to confirm the image.

Moreover, there is yet another preferable mode that the image encoding method further includes a header inserting step in which the rearrangement rule is inserted into at least one of an APP1 marker segment and an APP2 marker segment of the encoded data. According to this, when the scrambled encoded data is decoded, the relevant encoded data is decoded as the data which is still scrambled in the conventional decoding operation. In the case where the encoded data is decoded based on the rearrangement rule inserted therein, the encoded data can be descrambled and then decoded.

There is yet another preferable mode that the restart markers failing to follow predetermined correct order due to the rearrangement rule is rewritten so as to follow the correct order in the scramble conversion step. According to this, if the order of the restart marker is incorrect after the encoded data is scrambled, the standards of the JPEG format are violated. Then, the encoded data cannot be decoded in the conventional manner. However, by rewriting the restart marker so as to follow the proper order, such a wrong judgment that the encoded data may be destroyed can be prevented.

An image decoding method according to the present invention comprises:

a scramble conversion step in which encoded data is divided into a plurality of data using a restart marker and the divided data is rearranged based on a predetermined rearrangement rule; and

a decoding step in which the encoded data is decoded into image data based on the JPEG method using the restart marker. According to this, the data can be encoded with the restart marker included therein, and the encoded data scrambled after the data is rearranged every restart markers can be descrambled after the data is rearranged again based on the rearrangement rule. Thereby, the scrambled encoded data that cannot be confirmed in the conventional decoding operation can be decoded.

In addition, there is a preferable mode that the restart marker is set to be made cycling every predetermined numbers, and rearrangement is carried out between the data put together by a pair of restart markers located at order adjacent to each other in cycle of an arbitrary restart marker and the data put together by a pair of restart markers located at the same order as that of the pair of restart markers in cycle of another restart marker in the scramble conversion step. According to the foregoing mode, the standards of the JPEG format are not violated even after the encoded data is scrambled in the case of the same restart marker. As a result, the encoded data can be decoded in the conventional manner while it is more difficult to confirm the image.

As well, there is another preferable mode that the restart marker is set to be made cycling every predetermined numbers, and rearrangement is carried out between all of the data included in cycle of an arbitrary restart marker and all of the data included in cycle of another restart marker in the scramble conversion step. According to this, the encoded data is scrambled with n X macro block X predetermined serial numbers of the restart markers (n is a natural number), which facilitates the preparation of the conversion table. Thereby, the standards of the JPEG format are not violated even after the encoded data is scrambled. As a result, the encoded data can be decoded in the conventional manner while it is made more difficult to confirm the image.

In addition, there is another preferable mode that the restart marker is set to be made cycling every predetermined numbers, and random rearrangement is carried out between the data put together by a pair of restart markers located at order adjacent to each other in cycle of an arbitrary restart marker and the data put together by a pair of restart markers located at adjacent order to each other in cycle of another restart marker in the scramble conversion step. According to this, the scrambled encoded data violates the standards of the JPEG format, and it is impossible to decode the scrambled encoded data in the conventional manner. However, in the present invention, the image can be confirmed because the encoded data can be descrambled based on the rearrangement rule of the encoded data.

There is a yet another preferable mode that the image decoding method further includes a designating step and a display step, wherein

an arbitrary rearrangement rule is designated from a plurality of rearrangement rules in the designating step, and

the data is rearranged based on the arbitrary rearrangement rule designated in the designating step in the scramble conversion step, and

an image assisting the selection from the plurality of rearrangement rules is displayed in the display step if the particular rearrangement rule of the conversion table designated by the operator when the scrambled encoded data is encoded is not correctly inputted when the scrambled encoded data is decoded, the image cannot be confirmed even if the scrambled encoded data is decoded. However, according to the present invention, the encoded data can be descrambled based on the rearrangement rule of the encoded data, and the image can be thereby confirmed.

There is a yet another preferable mode that the data is alternately rearranged in a plurality of encoded data in the scramble conversion step. According to this, even though the encoded data including a plurality of images mixed at n x macro block (n is a natural number) unit is decoded as the scrambled encoded data in the conventional manner, the image cannot be confirmed. However, according to the present invention, the encoded data is descrambled based on the rearrangement rule of the encoded data so that the image can be confirmed.

Furthermore, there is a yet another preferable mode that the image decoding method further includes a header obtaining step in which the rearrangement rule is obtained from at least one of an APP1 marker segment and an APP2 marker segment of the encoded data. According to this, when the scrambled encoded data is decoded, the relevant encoded data is decoded as the image which is still scrambled in the conventional decoding operation. In the case where the encoded data is decoded based on the rearrangement rule inserted therein, the encoded data can be descrambled and then decoded.

There is a yet another preferable mode that the restart markers failing to follow predetermined correct sequence due to the rearrangement rule is rewritten so as to follow the correct sequence in the scramble conversion step. According to this, if the order of the restart marker is incorrect after the encoded data is descrambled, the standards of the JPEG format are violated, and the conventional decoding becomes impossible. However, in the present invention, the data can be decoded in the conventional manner by rewriting the restart marker so as to follow the correct order. As a result, such a wrong judgment that the encoded data may be destroyed can be prevented.

According to the image encoding apparatus and method of the present invention, the image data is encoded as the encoded data including the restart marker, and the data is rearranged every restart marker and then scrambled. Therefore, when the scrambled encoded data is decoded in the conventional manner, it becomes difficult to confirm the image generated from the decoded data. As a result, the confidentiality of the image can be protected.

According to the image decoding apparatus and method of the present invention, the encoded data, which is encoded in a state where the restart marker is included therein and rearranged every restart marker and then scrambled, can be rearranged again based on the rearrangement rule of the relevant data and then descrambled. Therefore, the scrambled encoded data that cannot be confirmed in the conventional decoding operation can be decoded.

The image encoding and decoding technology according to the present invention is useful as an image processing apparatus in which a communication line is not provided such as a digital camera, and the like.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating a constitution of an image encoding/decoding apparatus according to a preferred embodiment 1 of the present invention.

FIGS. 2A and 2B are conceptual illustrations of encoded data based on the JPEG method with or without restart markers.

FIG. 3 is a conceptual diagram of a constitution of the encoded data based on the JPEG method according to the preferred embodiment 1.

FIGS. 4A and 4B are illustrations of an image into which restart markers are inserted according to the preferred embodiment 1.

FIGS. 5A and 5B are conceptual illustrations of the encoded data shown in FIGS. 4A and 4B in which positions of the restart markers are rearranged according to the preferred embodiment 1.

FIGS. 6A and 6B respectively show macro blocks diagram corresponding to FIGS. 5A and 5B according to the preferred embodiment 1.

FIGS. 7A and 7B are conceptual diagram of display patterns corresponding to FIGS. 6A and 6B according to the preferred embodiment 1.

FIG. 8 is a conceptual diagram of the encoded data into which the restart marker is inserted as macro block unit to the image shown in FIG. 4 according to the preferred embodiment 1.

FIG. 9 is a conceptual diagram of the encoded data showing a positional relationship of the macro blocks when data FFD0-FFD0 are rearranged as a unit according to the preferred embodiment 1.

FIGS. 10A and 10B respectively show macro blocks diagram corresponding to FIG. 9 according to the preferred embodiment 1.

FIGS. 11A and 11B are conceptual diagram of display patterns corresponding to FIGS. 10A and 10B according to the preferred embodiment 1.

FIGS. 12A and 12B are conceptual diagram of the encoded data in which the data shown in FIG. 8 is randomly rearranged according to the preferred embodiment 1.

FIGS. 13A and 13B are conceptual diagram of display patterns corresponding to FIGS. 12A and 12B according to the preferred embodiment 1.

FIG. 14 is an illustration of a plurality of rearrangement rules according to the preferred embodiment 1.

FIGS. 15A and 15B are illustrations of an image into which the restart markers are inserted according to the preferred embodiment 1.

FIGS. 16A and 16B respectively show a diagram of the restart markers corresponding to FIGS. 4A, 4B, 15A and 15B according to the preferred embodiment 1.

FIGS. 17A and 17B are conceptual diagram of the encoded data shown in FIGS. 16A and 16B after the data rearrangement according to the preferred embodiment 1.

FIGS. 18A and 18B are conceptual diagram of display patterns corresponding to FIGS. 17A and 17B according to the preferred embodiment 1.

FIGS. 19A and 19B are conceptual diagram respectively showing a display on a frame of a selected range in FIG. 4 and the encoded data in which the data is rearranged in the selected range according to the preferred embodiment 1.

FIGS. 20A and 20B are conceptual diagram of display patterns corresponding to FIGS. 19A and 19B according to the preferred embodiment 1.

FIG. 21 is a conceptual diagram of the encoded data in which the rearrangement rule (pattern) is inserted into an APP1 marker segment of the encoded data according to the preferred embodiment 1.

FIG. 22 is a conceptual diagram of the encoded data in which the rearrangement rule (order of the restart markers) is inserted into the APP1 marker segment of the encoded data according to the preferred embodiment 1.

FIGS. 23A and 23B are conceptual diagram respectively showing the rearranged encoded data and the rewritten encoded data according to the preferred embodiment 1.

FIG. 24 is a block diagram showing a constitution of an image encoding apparatus according to a preferred embodiment 2 of the present invention.

FIG. 25 is a block diagram showing a constitution of an image decoding apparatus according to the preferred embodiment 2.

### DETAILED DESCRIPTION OF THE INVENTION

Hereinafter, preferred embodiments of an image encoding/decoding apparatus according to the present invention are described in detail referring to the drawings.

### Preferred Embodiment 1

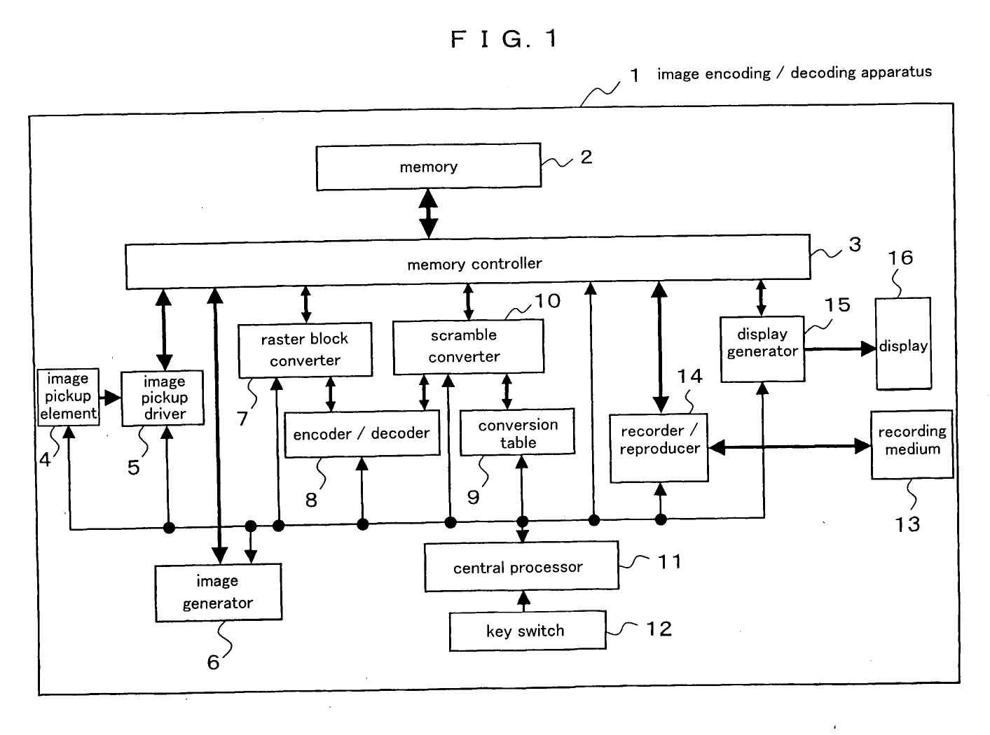

As shown in FIG. 1, an image encoding/decoding apparatus 1 comprise a memory 2, a memory controller 3, an image pickup element 4, an image-pickup driver 5, an image generator 6, a raster block converter 7, an encoder/decoder 8, a conversion table 9, a scramble converter 10, a central processor 11, key switch 12, a recording medium 13, a recorder/reproducer 14, a display generator 15 and a display 16.

The image pickup element 4 converts a light from a photogenic subject into a video signal. The image pickup element 4 consists of a CCD (Charge Coupled Device) sensor, a CMOS (Complementary Metal oxide Semiconductor) sensor or the like.

The memory 2 stores RAW data outputted from the image pickup element 4, image data including luminance and color-difference signals, JPEG-encoded data and the like. The memory 2 consists of a recording medium such as SDRAM (Synchronous Dynamic Random Access Memory) or DDR-SDRAM.

The memory controller 3 controls to write/read data with respect to the memory 2 in accordance with a writing/reading request to the memory 2. The image-pickup driver 5 outputs an access request to the memory controller 3. The access request is a request for storing the RAW data outputted from the driven image pickup element 4 in the memory 2.

The image generator 6 issues a request for reading the RAW data stored in the memory 2 and a request for writing image data in the memory 2 to the memory controller 3 to thereby convert the RAW data into the image data.

The raster block converter 7 requests the memory controller 3 to read the image data from the memory 2 and executes macro block access to the image data. The encoder/decoder 8 compresses and extends the data using the restart marker based on the JPEG method. The conversion table 9 records therein a rearrangement rule for the encoded data every restart marker. The scramble converter 10 scrambles the encoded data. More specifically, the scramble converter 10 requests the memory controller 3 to write the scrambled encoded data in the memory 2, and rearranges the respective data constituting the encoded data outputted from the encoder/decoder 8 every restart marker based on the conversion table 9. The central processor 11 controls the respective components. The key switch 12 accepts an input of the conversion table 9 and an input of a password designated by an operator. The recording medium 13 consists of attachable or removable recording medium, such as a memory or HDD (Hard disc Drive. The recorder/reproducer 14 records the data in the recording medium 13 and the memory 12 via the memory controller 3, and reproduces the data in the recording medium 13 and the memory 2 via the memory controller 3. The display generator 15 generates display data from the image data stored in the memory 2 and the image data reproduced from the recording medium 13. The display 16 displays the display data outputted from the display generator 15. The display 16 consists of a display device, such as LCD (Liquid Crystal Display) or an organic EL (Electronic Luminescence).

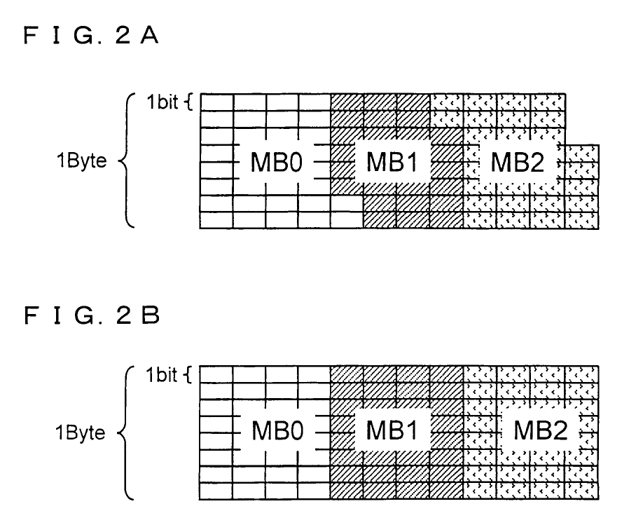

FIG. 2A shows a conventional conceptual diagram of the encoded data based on the JPEG method in which the restart marker is not used. As shown in FIG. 2A, the data is constituted bit-by-bit and every macro block. In the JPED method, each macro block is affected by a proximate DC component, which makes it not possible to cut off the encoded data at a unit of the macro block. FIG. 2B is shows a conceptual diagram of the case where the restart marker is inserted every macro block, wherein the encoded data is completed byte-by-byte every restart marker, and the encoded data can be cut off without any influence from the proximate DC component.

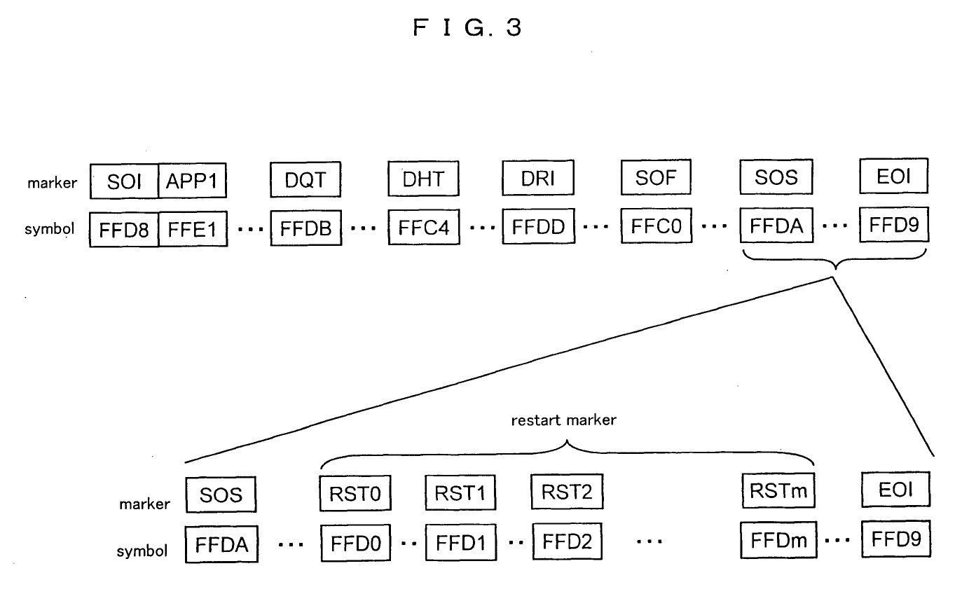

FIG. 3 is a conceptual diagram of the constitution on the encoded data based on the JPEG method. When the restart marker is used, the corresponding restart markers (RST) are inserted respectively into data FFD0-FFD7 framed in by a SOS marker (FFDA) and an EOI marker (FFD9).

There is the following constitution that the scramble converter 10 rearranges the data per the restart marker in accordance with the rearrangement rule of the conversion table 9.

Mode 1

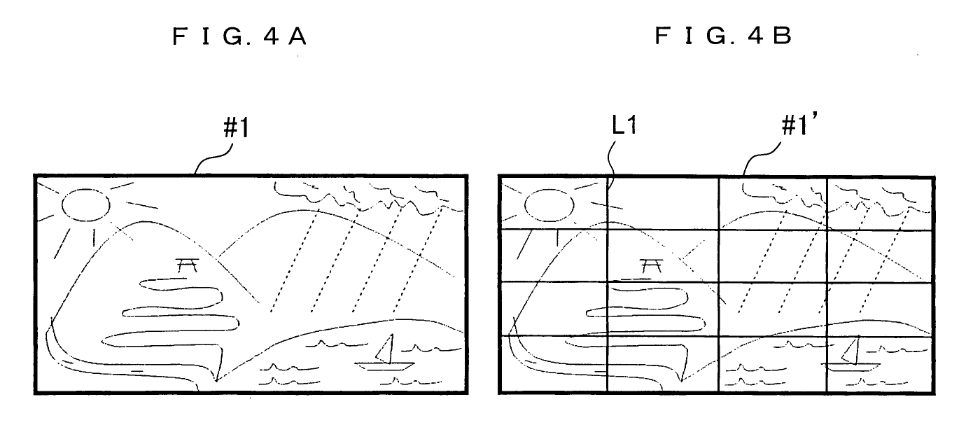

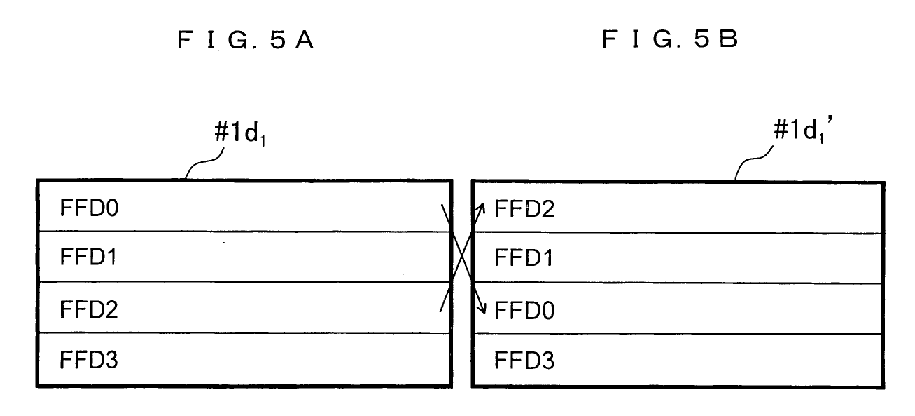

FIG. 4A shows an image #1 based on the encoded data in which the restart markers are inserted at a unit of four macro blocks. FIG. 4B shows an image #1′ to which border lines L1 are added so that borders between the macro blocks can be more easily confirmed. FIG. 5A shows a arrangement state of the restart markers inserted at a unit of four macro blocks. In this description, the four macro blocks, which is a unit for the arrangement of the restart markers, is set to be number of blocks corresponding to a length of a horizontal line in the drawing. However, this is merely an example.

According to the state where the restart markers are arranged shown in FIG. 5A, encoded data #1d₁ having the data FFD0-FFD3 constitutes the image #1 shown in FIG. 4A. In FIGS. 4A and 5A, in which respective spatial positions are identical, the data FFD0 corresponds to an image region at an uppermost ¼ part in FIG. 4A, the data FFDL corresponds to an image region at an intermediate upper ¼ part in FIG. 4A, the data FFD2 corresponds to an image region at an intermediate lower ¼ part in FIG. 4A, and the data FFD3 corresponds to an image region at a lowermost ¼ part in FIG. 4A. FIG. 5B is a conceptual diagram of encoded data #1d₁′ obtained by the rearrangement of the encoded data #1d₁ (data FFD0-FFD3) shown in FIG. 5A using the scramble converter 10. Describing the rearrangement recited herein, in the predetermined numbers of restart markers in cycling (RST0, RST1, RST3, . . . , RSTm), the data FFD0-FFDm put together by an arbitrary restart marker and a restart marker located at a subsequent order is handled as a unit, and the data FFD0-FFDm are replaced with one another. In the present example, the data FFD0 in the first line shifts to the third line, and the data FFD2 in the third line shifts to the first line.

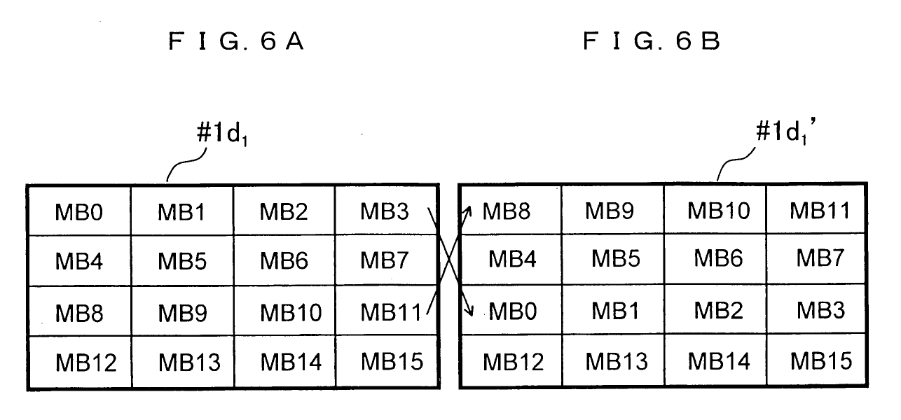

FIGS. 6A and 6B respectively show the alignment structure of macro blocks MB0-MB15 corresponding to the alignment structure of the data FFD0-FFD3 shown in FIGS. 5A and 5B. FIG. 6A corresponds to FIG. 5A, while FIG. 6B corresponds to FIG. 5B. In FIGS. 6A and 6B, the macro blocks MB0-MB3 in the first line shift to the third line, and the macro blocks MB8-MB11 in the third line shift to the first line. A divisional unit of the macro blocks MB0-MB15 is four blocks. Therefore, the four macro blocks still constitute the continuous data as a group of macro blocks after the rearrangement.

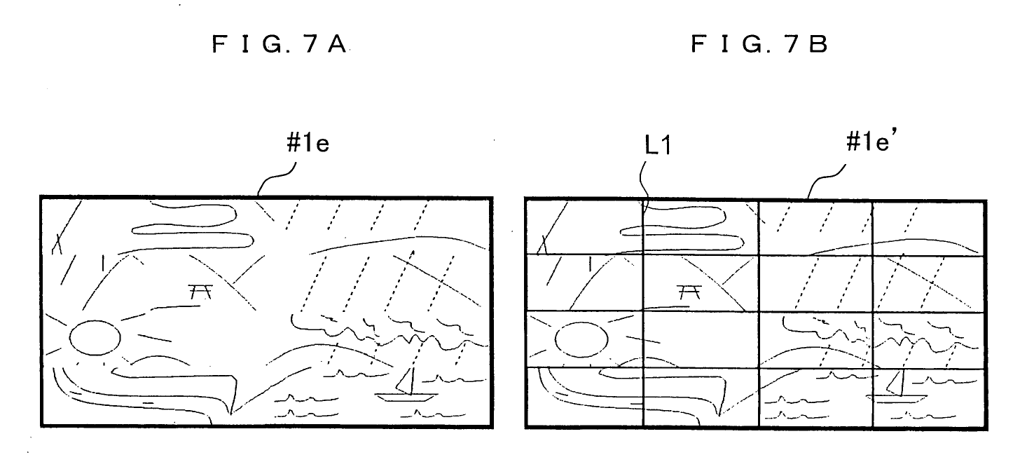

FIG. 7A is a conceptual diagram of a display state #1e obtained in such a manner that the encoded data #1d₁′ having a structure of the macro blocks as shown in FIG. 6B is rewritten based on the rearrangement rule of the conversion table 9 in the scramble converter 10, and the rewritten encoded data #1d′ is reproduced (decoded) by the decoder 8 and displayed on the display 16 by the display generator 15. FIG. 7B shows a display state #1e′ in which the borders of the macro blocks can be visually confirmed by adding the border lines L1 to the display pattern shown in FIG. 7A. It is known that the same images are reproduced in the same macro blocks as those shown in FIGS. 4A and 4B in these drawings. It is known from the drawings that the display pattern of the image #1 shown in FIG. 4A, which is the original image, is out of shape and can hardly be visually confirmed as the image because the data FFD0-FFD3 are rearranged at a unit of restart marker. In comparison to the image #1 shown in FIG. 4A, the image region in the first line shifts to the third line, and the image region in the third line shifts to the first line in the display pattern 1#e shown in FIG. 7A. The encoded data #1d₁′ is recorded in the recording medium 13 via the recorder/reproducer 14.

Even in the case where the encoded data #1d₁′ is in the states shown in FIGS. 5A, 6A and 7A, the same conversion table 9, which was used when the data was encoded, is also used when the encoded data is decoded, and then, the data put together by the restart markers can be put back as in its original state and reproduced. As a result, the non-scrambled image #1 shown in FIG. 4A can be reproduced.

Mode 2

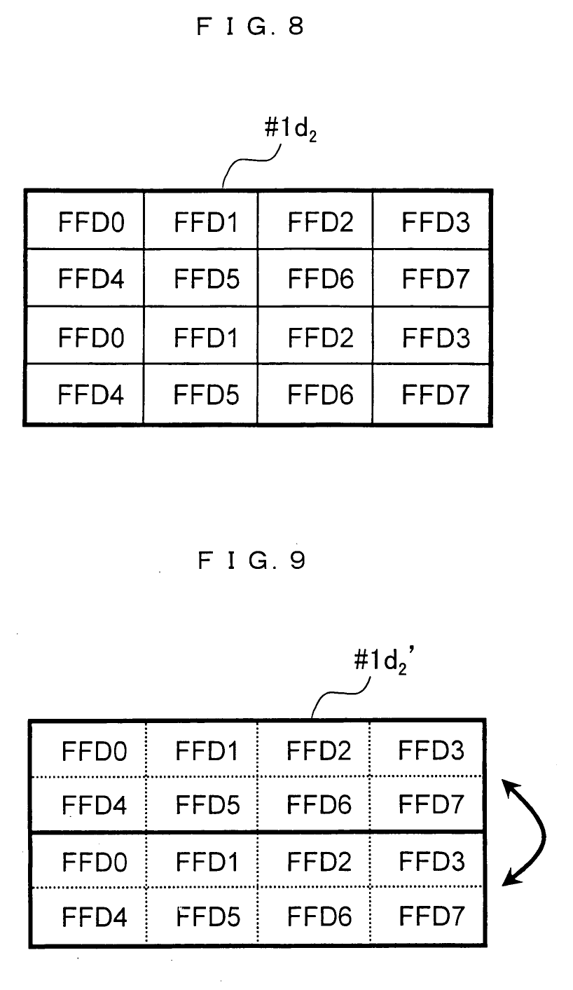

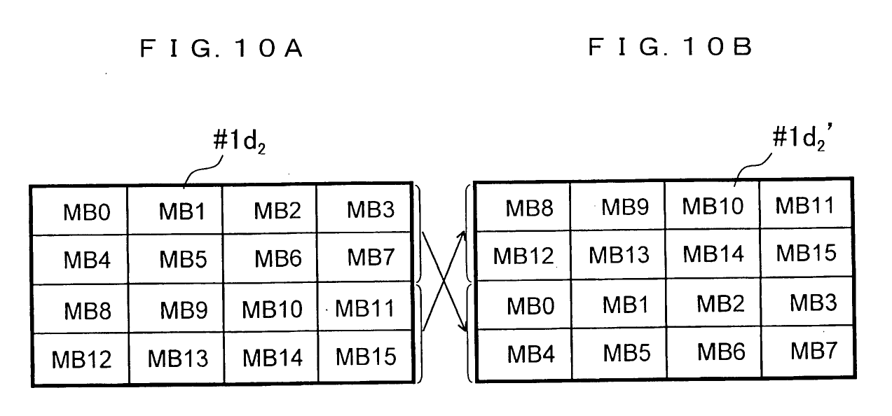

FIG. 8 shows encoded data #1d₂ in which the restart marker is inserted at a unit of one macro block. In the following description, the same image as that of FIG. 4A is assumed as an original image of the encoded data #1d₂ shown in FIG. 8. Because there is the relationship of one macro block=one restart marker, the restart markers as many as the macro blocks are present. According to the alignment state of the restart markers in the encoded data #1d₂ shown in FIG. 8, the data FFD0-FFD7 constitute the encoded data #1d₂. FIG. 10A shows the alignment state of the macro blocks in the encoded data #1d₂. FIG. 9 shows encoded data #1d₂′ in which the data (FFD0, FFD1, . . . , FFD7) is rearranged based on the rearrangement rule of the conversion table 9 in the scramble converter 10. Referring to the rearrangement recited here, all of the predetermined numbers of the restart markers in cycling (RST0, RST1, . . . , RST7) are handled as a unit and rearranged. FIG. 10B shows the alignment structure of the macro blocks in the encoded data #1d₂′ corresponding to the arrangement shown in FIG. 9.

In the mode 2, when the encoded data is scrambled with n X macro block X predetermined numbers of cycle (n is a natural number) as a unit, n=1, and predetermined numbers of cycle=8. Because it is one macro block=one restart marker, it is known that the eight continuous macro blocks constitute a unit and the data is rearranged. The first and second lines shift to the third and fourth lines respectively, while the third and fourth lines shift to the first and second lines respectively.

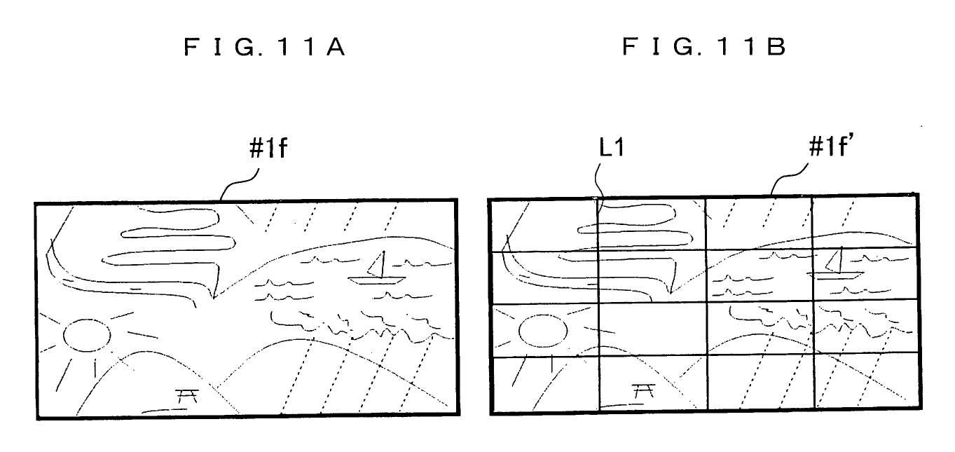

FIG. 1A shows a display pattern #1f in which the encoded data #1d₂′ is rearranged as shown in FIG. 10B is reproduced in a manner similar to FIG. 5B. FIG. 11B shows a display pattern #1f in which the border lines L1 are further added to the display pattern #1f shown in FIG. 11A so that the borders between the macro blocks can be more easily confirmed. In the display patterns shown in FIGS. 11A and 11B, the first and second lines shift to the third and fourth lines respectively, and the third and fourth lines shift to the first and second lines respectively in comparison to the images #1 and #1′ shown in FIGS. 4A and 4B. It is known that the same images are reproduced in the same macro blocks as those shown in FIG. 4. It is also known that all of the predetermined numbers of restart markers in cycling are handled as a unit and the data is then rearranged, and the image #1 shown in FIG. 4A is thereby out of shape, which makes it difficult to confirm the image.

And, even though it is the encoded data #1d₂ shown in FIG. 10A, the conversion table 9, which was used when the data was encoded, is used in the decoding so that the data put together by the restart markers is put back to its original state and reproduced. As a result, the non-scrambled image #1 shown in FIG. 4A can be reproduced.

Mode 3

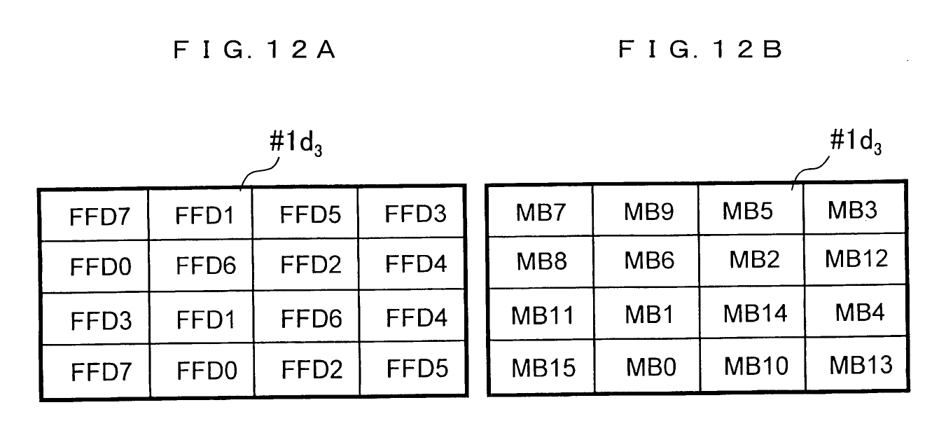

FIG. 12A shows the arrangement state of the restart markers in encoded data #1d₃ wherein the restart marker inserted at a unit of one macro block, and the data put together by an arbitrary restart marker and a restart marker adjacent thereto in the predetermined numbers of the restart markers in cycling, which is handled as a unit, constitute the data FFD0-FFD7 as a unit, and then the data FFD0-FFD7 are randomly rearranged based on the rearrangement rule of the conversion table 9 in the scramble converter. FIG. 12B shows the arrangement state of the macro blocks MB0-MB15 in the encoded data #1d₃. Only the eight of the restart markers RST0-RST7 is provided corresponding to the eight data FFD0-FFD7, however, the data FFD0-FFD7 and the macro blocks MB0-MB15 represented by the same restart markers in a screen are different to one another as shown in FIG. 12B. Tracing the macro blocks MB0 through the macro block MB15 in that order, the data FFD0-FFD7 are repeated twice.

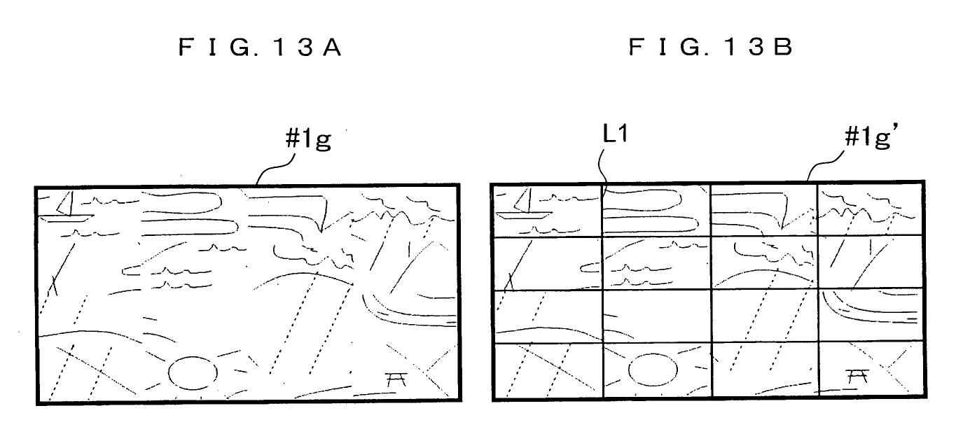

FIG. 13A is a conceptual diagram of a display pattern #1g reproduced in a manner similar to that of the encoded data #1d₁′ shown in FIG. 5B by rewriting the encoded data #1d, in which the data FFD0-FFD7 and the macro blocks MB0-MB15 are arranged, according to descending/ascending orders of the data FFD0, FFD1, . . . , FFD7, that is, the restart markers RST0, RST1, . . . , RST7 based on the rearrangement rule of the conversion table 9 as shown in FIGS. 12A and 12B. FIG. 13B shows a display pattern #1g′ to which the border lines L1 are further added to the display pattern #1g shown in FIG. 13A so that the borders between the macro blocks can be clearly seen. It is known that the same images are reproduced in the same macro blocks as those shown in FIG. 4. It is learnt that the image #1 shown in FIG. 4A is out of shape and the macro blocks lose a mutual correlation much more between them by rearranging the macro blocks randomly at a unit of restart marker, which makes it more difficult to visually confirm the image.

And then, even though it is the encoded data #1d₃ shown in FIG. 12A, the conversion table 9, which was used when the data was encoded, is used in the decoding, and thereby, the encoded data put together by the restart markers is put back to its original sate and reproduced. As a result, the image #1 of FIG. 4, which is not scrambled, can be reproduced.

Mode 4

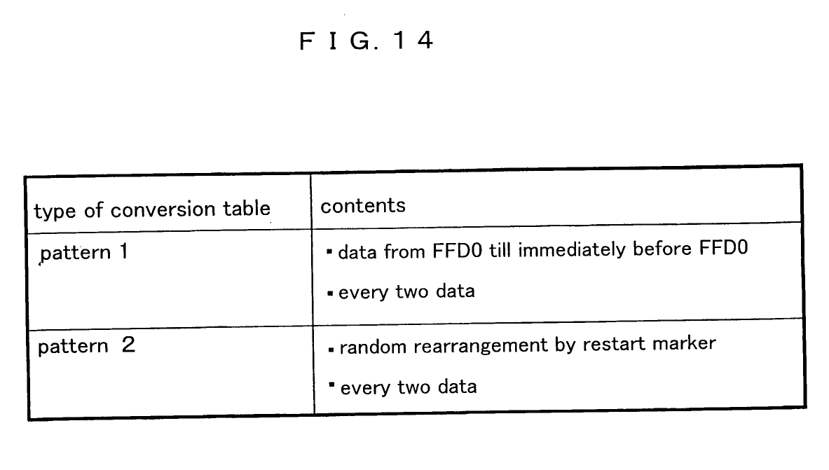

FIG. 14 shows selected image data of a plurality of rearrangement rules displayed on the display 16 of the image encoding/decoding apparatus 1 shown in FIG. 1. The two rearrangement rules previously decided are read from the conversion table 9, and the operator designates the rearrangement rule of the conversion table 9 using the key switch 12 to thereby be capable of rearranging the data in accordance with a pattern 1 or a pattern 2. Descriptions are omitted because an effect obtained by the pattern 1 is the same as that of FIG. 9, and an effect obtained by the pattern 2 is the same as that of FIG. 12A.

The encoded data in which the data is rearranged can regain its original data arrangement and be reproduced in such a manner that the key switch 12 designates the rearrangement-rule when the encoded data is decoded so that the scramble operation when the data is encoded is tracked back. In the case where the rearrangement rule designated when the encoded data is decoded is different to the rearrangement rule designated when the data is encoded, the scramble is not properly released.

Mode 5

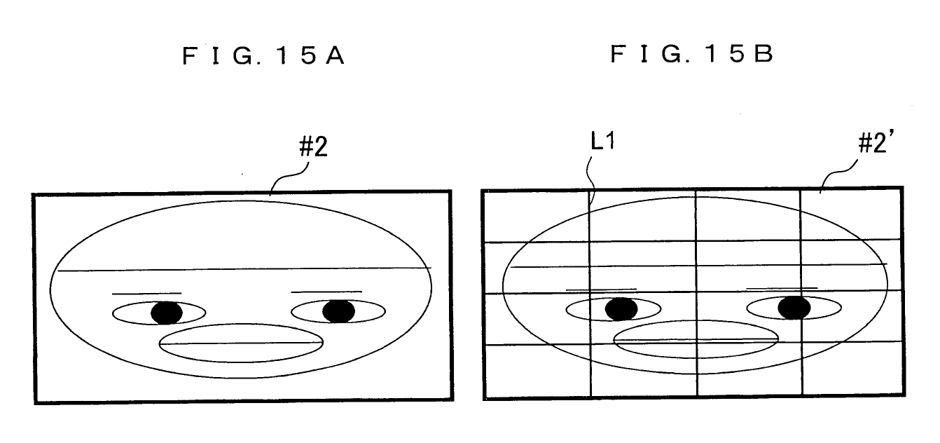

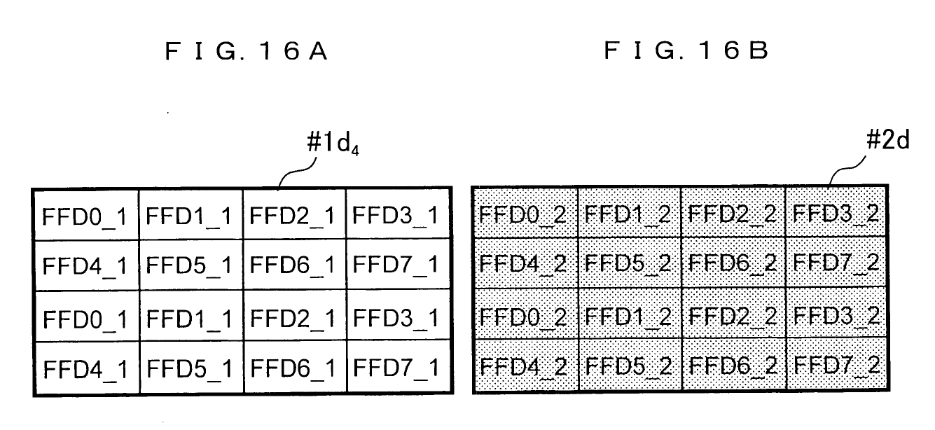

FIG. 15A shows an image #2 having the same size and the same number of macro blocks as that of FIG. 4A. FIG. 15B shows an image #2′ to which the border lines L1 are added so that the borders between the macro blocks can be clearly recognized. FIG. 16A is a conceptual diagram of encoded data #1d₄ where the restart marker is inserted at a unit of one macro block in the encoded data constituting the image #1 shown in FIG. 4A. FIG. 16B is a conceptual illustration of encoded data #2d where the restart marker is inserted at a unit of one macro block in the encoded data constituting the image #2 shown in FIG. 15A. In order to clarify the difference between the image #1 and the image #2, “_{—}1” and “_{—}2”, are added to tails of the data symbols put together by the restart markers.

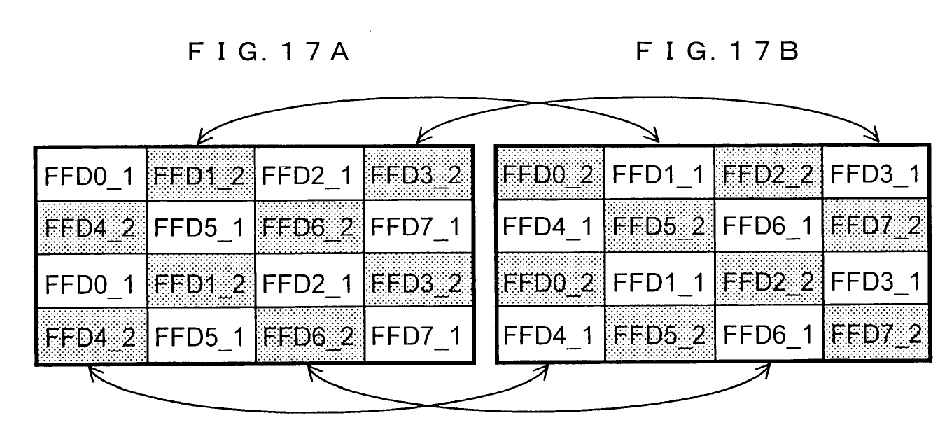

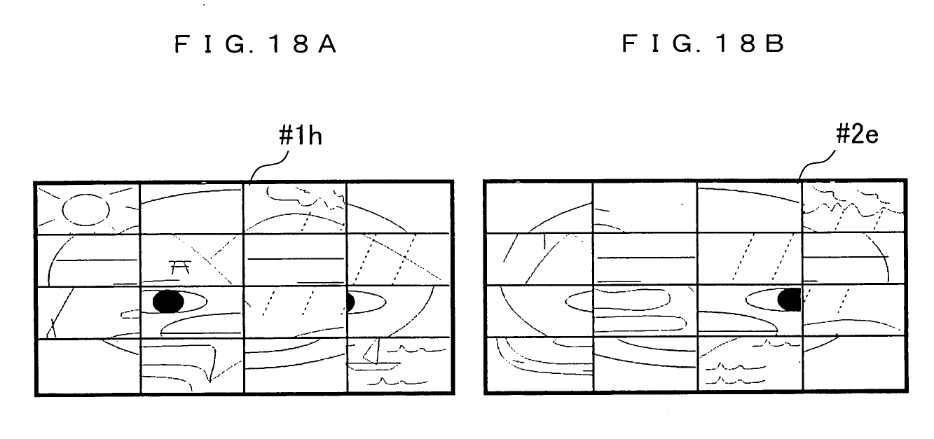

FIGS. 17A and 17B are conceptual diagram of encoded data #1d₄′ and encoded data #2d′ obtained as a result of the data rearrangement in the encoded data #1d₄ and #2d based on the rearrangement rule of the conversion table 9 in the scramble converter 10. As is clear from FIGS. 17A and 17B, the same restart markers are mixed in an alternate manner in the two encoded data), which shows the rearrangement in a mosaic-like checker board pattern. Though the symbols are provided in the drawings for convenience, the actual encoded data, in which the data is arranged in the order of FFD0, FFD1, . . . , FFD7, can be reproduced. FIGS. 18A and 18B respectively show a display pattern #1h and a display pattern #2e resulting from the reproduction of the encoded data #1d₄′ and #2d′. It is known from the drawings that the same macro blocks display the same images as the original images. The images #1h and #2e result from the data rearrangement of the images #1 and #2 in FIGS. 4A and 15A in the mosaic-like checker board pattern. Thus, in the mode 5, the macro blocks lose a mutual correlation between them much more in comparison to the original images #1 and #2 by rearranging the data alternately in the plurality of encoded data, which makes it more difficult to visually confirm the image.

The procedures in encoding the data are traced back when the encoded data is decoded so that the data is rearranged in its original state in the images and reproduced. As a result, the original non-scrambled images #1 and #2 of FIGS. 4A and 15A can be obtained as the display patterns.

Mode 6

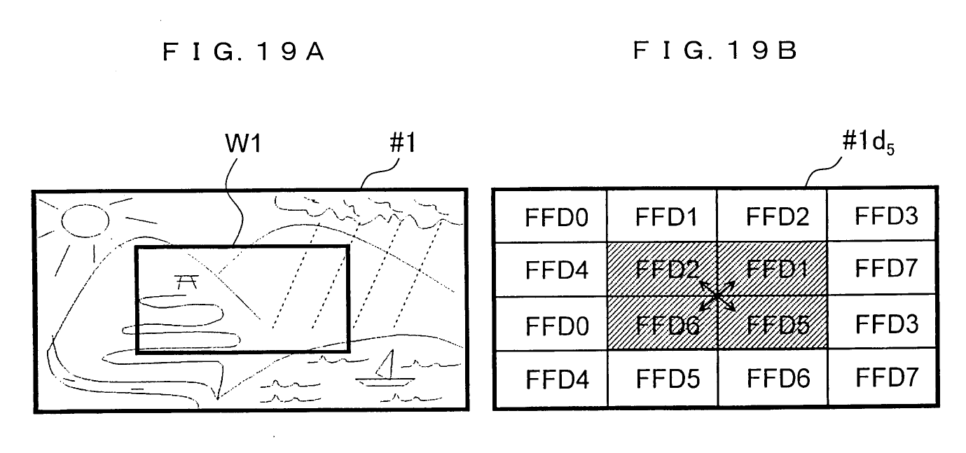

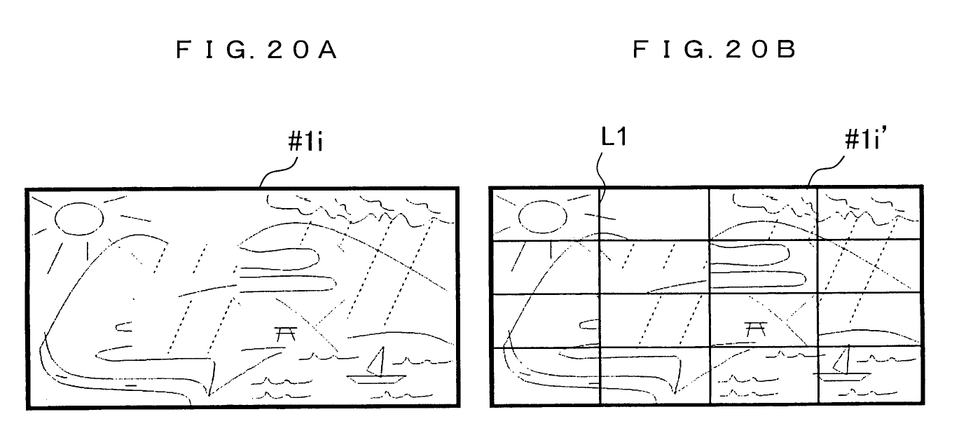

FIG. 19A is a conceptual diagram of the image #1 (see FIG. 4A) in which the data is rearranged after a range W1 to which the rearrangement rule of the conversion table 9 is applied is designated by the key switch 12 in the scramble converter 10. FIG. 19B shows encoded data #1d₅ in which the data is rearranged only in the range W1 previously designated in the state where the encoded data #1d to which the restart markers inserted therein as shown in FIG. 8 is prepared based on the image #1 shown in FIG. 4. In the encoded data #1d₅ in which the data is limitedly rearranged in the range W1, the restart markers are discontinuous in sequence. FIG. 20A shows a display pattern #1i resulting from the reproduction of the encoded data #1d₅ in which the data is rewritten in the order of FFD0, FFD1, . . . FFD7. FIG. 20B shows a display pattern #1i′ in which the border lines L1 are further added to the display pattern #1i of FIG. 20A so that the borders of the macro blocks can be clearly seen. It is known from the drawing that only the data in the range W1 is rearranged. In this case, the data is diagonally rearranged. By doing so, a face of an arbitrary person can be scrambled.

The non-scrambled image #1 of FIG. 4A can be reproduced even from the encoded data #1d₅ shown in FIG. 19B by applying the conversion table 9 used in encoding the data when the encoded data is decoded.

Mode 7

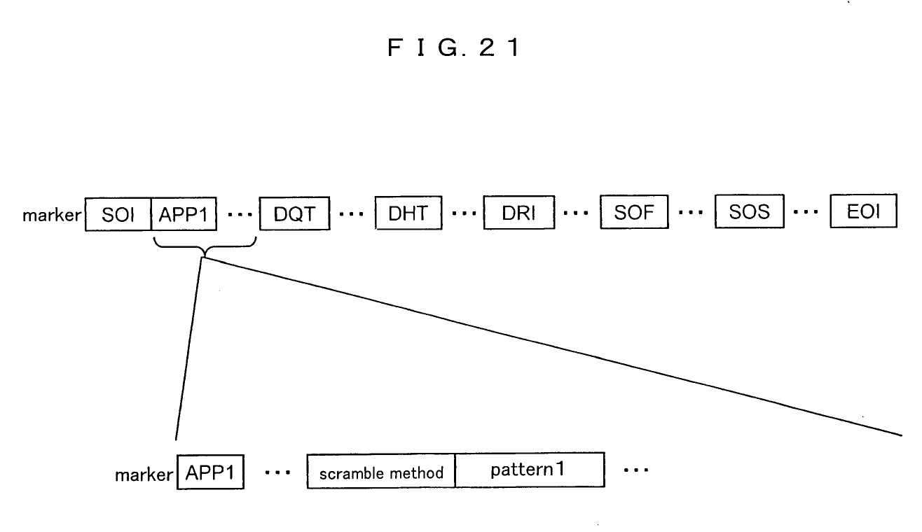

FIG. 21 is a conceptual diagram of a state where the rearrangement rule of the conversion table 9 used in FIG. 14 is inserted into an APP1 marker segment of the encoded data. In the present mode, the central processor 11 inserts the APP1 marker into the encoded data that should be rearranged. Conventionally, a filming information, such as exposure time and information on kind of a filming device, is embedded in the APP1 marker. The encoded data is apparently regular encoded data and can be reproduced in a conventional image-decoding device by embedding the rearrangement rule into the APP1 marker. However, as the encoded data is scrambled when it remains intact, the rearrangement rule is extracted from the APP1 marker and the encoded data is reproduced based on the extracted rearrangement rule so that the descrambled image data can be obtained.

Mode 8

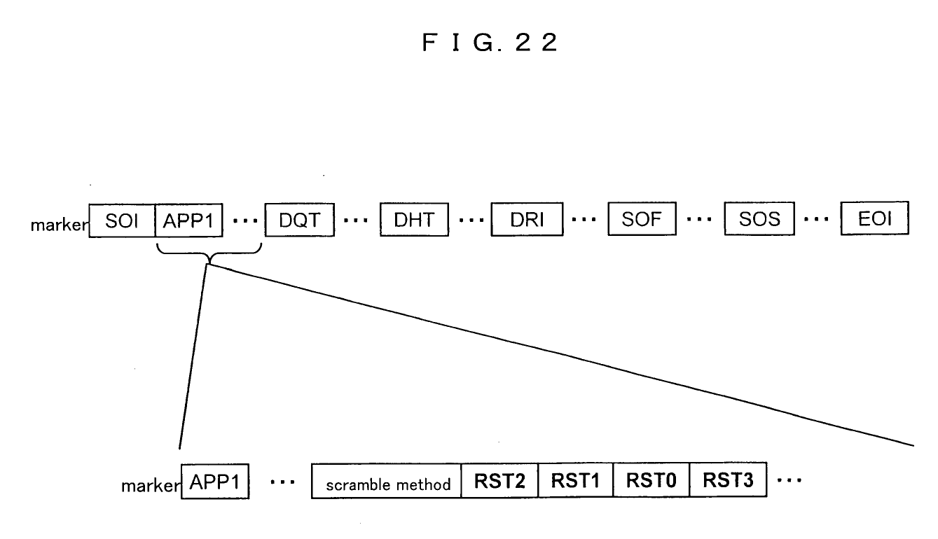

FIG. 22 is a conceptual diagram of a state where the order of the restart markers after they are rearranged is inserted into the APP1 marker segment of the encoded data. The mode 5 can also be applied to the rearrangement shown in FIG. 5B (encoded data #1d₁′). The conversion table 9 embedded in the APP1 marker is extracted by the central processor 11 when the data is reproduced, and the non-scrambled display format can be obtained by applying the extracted conversion table 9 in the decoding.

Mode 9

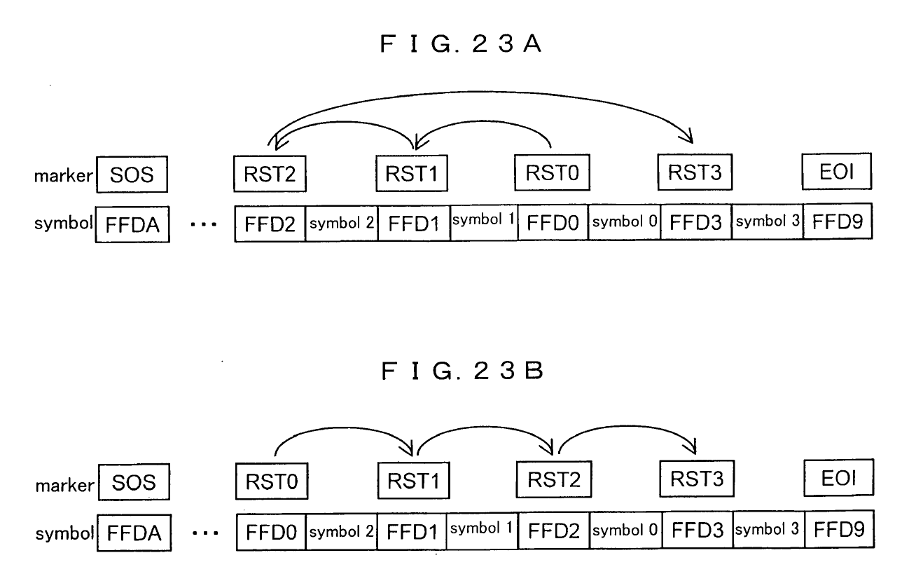

FIGS. 23A and 23B are conceptual diagram of the encoded data before and after the restart markers failing to follow the order of the restart markers (RST0, RST1, . . . , RST7) corresponding to the predetermined correct data order (FFD0, FFD1, . . . , FFD7) in accordance with the JPEG method described in FIG. 5, are rewritten so as to follow the predetermined correct data order in accordance with the JPEG method. FIG. 23A shows the encoded data before the rewriting, while FIG. 23B shows the encoded data after the rewriting. Before the rewriting, the restart markers are random in the order and cannot comply with the JPEG standards. Therefore, the encoded data cannot be reproduced by the conventional image decoding apparatus. Consequently, only the restart markers are rewritten in order to comply with the JPEG standards so that the scrambled data can be reproduced. At the time, the scrambled encoded data can be reproduced because only the restart markers are rewritten, while any data attached to the restart markers is not rewritten as shown in FIG. 23B. When the encoded data is reproduced, the encoded data in the state of FIG. 23B is rewritten to be the data state shown in FIG. 23A based on the conversion table 9, the data put together by the restart markers is rearranged, further the encoded data in which the data is rearranged is reproduced by the encoding/decoding apparatus, and the display data is generated from the reproduction data by the display generator 15 and displayed on the display 16. By doing so, the image is descrambled and then reproduced.

### Preferred Embodiment 2

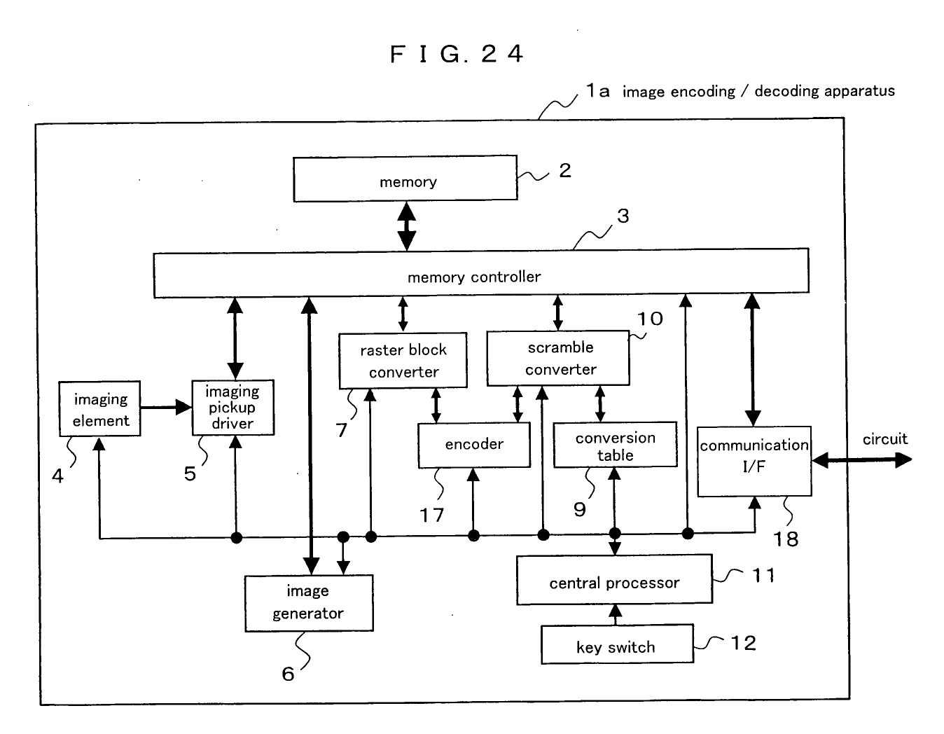

As shown in FIG. 24, an image encoding apparatus la according to a preferred embodiment 2 of the present invention comprises a memory 2, a memory controller 3, an image pickup element 4, an image-pickup driver 5, an image generator 6, a raster block converter 7, an encoder 17, a conversion table 9, a scramble converter 10, a central processor 11, a key switch 12, and a communication I/F 18.

The image pickup element 4 converts a light from a photogenic subject into a video signal. The image pickup element 4 consists of a CCD sensor, a CMOS sensor or the like. The memory 2 stores RAW data outputted from the image pickup element 4, image data including luminance and color-difference signals, JPEG-encoded data and the like. The memory 2 consists of a recording medium such as SDRAM or DDR-SDRAM. The image-pickup driver 5 outputs an access request to the memory controller 3 in order to store the RAW data outputted from the driven image pickup element 4 in the memory 2. The memory controller 3 writes/reads data with respect to the memory 2 in accordance with a writing/reading request to the memory 2. The image generator 6 issues a request for reading the RAW data stored in the memory 2 and a request for writing image data in the memory 2 to the memory controller 3 to thereby convert the RAW data into the image data. The raster block converter 7 requests the memory controller 3 to read the image data from the memory 2 and executes macro block access to the image data. The encoder 17 compresses (encodes) the data using the restart marker based on the JPEG method. The conversion table 9 records a rearrangement rule for the encoded data therein. The scramble converter 10 requests the memory controller 3 to write the scrambled encoded data in the memory 2, and rearranges the respective data constituting the encoded data outputted from the encoder 17 every restart marker based on the conversion table 9 to thereby scramble the encoded data. The central processor 11 controls the respective components. The key switch 12 accepts inputs of the conversion table 9 and a password designated by the operator. The communication I/F 18 executes a communication using LAN or a circuit.

The image encoding apparatus 1a is an apparatus for exclusive use of recording connected to a network such as a monitor camera, wherein encoded data is scrambled in being recorded and the scrambled encoded data is outputted to the network. The scrambling operation for the encoded data is the same as that of the preferred embodiment 1, and is not described again.

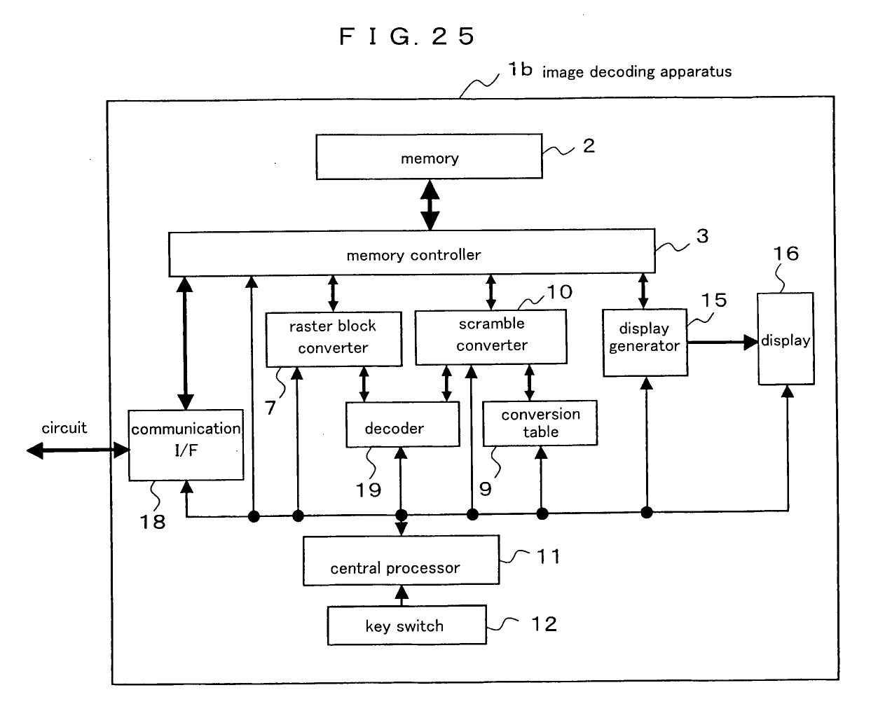

An image decoding apparatus 1b for decoding the encoded data outputted by the image encoding apparatus 1a is shown in FIG. 25. The image decoding apparatus 1b comprises a memory 2, a memory controller 3, a raster block converter 7, a conversion table 9, a scramble converter 10, a key switch 12, a communication I/F 18, and a decoder 19.

The memory 2 stores the image data including luminance signal and color-difference signal, JPEG-encoded data and the like. The memory 2 consists of a recording medium such as SDRAM or DDR-SDRAM. The memory controller 3 writes/reads the encoded data with respect to the memory 2 in accordance with a writing/reading request to the memory 2. The raster block converter 7 requests the memory controller 3 to read the encoded data from the memory 2 and executes macro block access to the encoded data. The decoder 19 extends the encoded data using the restart marker based on the JPEG method. The conversion table 9 records a rearrangement rule for the encoded data therein. The scramble converter 10 requests the memory controller 3 to read the scrambled encoded data from the memory 2, and further rearranges the respective data constituting the encoded data read from the memory 2 every restart marker based on the conversion table 9 and supplies the rearranged encoded data to the decoder 19. The decoder 19 descrambles the encoded data supplied from the scramble converter 10. The central processor 11 controls the respective components. The key switch 12 receives inputs of the conversion table 9 and a password designated by the operator. The communication I/F 18 executes a communication using LAN or a circuit.

In the image decoding apparatus 1b, the communication I/F 18 records the scrambled encoded data transmitted via the circuit in the memory 2 via the memory controller 3. The descramble operation for the encoded data is the same as that of the preferred embodiment 1, and the explanation is neglected here.

As described above, according to the image encoding apparatus 1a and the image decoding apparatus 1b, even if the encoded data under mid flow of transmission is reproduced in a different decoding apparatus, the encoded data can be reproduced only in a state of the scrambled data so as to assure the security. Even if the image decoding apparatus 1b shown in FIG. 25 is used at the time, the image cannot be properly reproduced unless the conversion table 9 is correctly designated via the key switch 12.

The present invention is not limited to the foregoing preferred embodiments, and may include the following modes.

1) There are two selection patterns via the key switch 12 in the preferred embodiments described above, however, the present invention is not limited thereto. There may be more than two patterns obtained through the combination of the inventions.

2) The number of the macro blocks is “16” for the convenience of description in the preferred embodiments described above, however, the present invention is not limited thereto. The number of the macro blocks may be any number that allows the data to be encoded based on the JPEG method.

3) The data is rearranged in the two images in the preferred embodiments described above, however, the present invention is not limited thereto. The data in more than two images may be rearranged.

4) The description is based on the shape of the macro blocks having such a horizontal length as 4:4:2 in the preferred embodiments described above, however, the present invention is not limited thereto. The shape of the macro block may be 4:4:4 or 4:2:0, which are the shapes of the macro block shape in the JPEG method.

Though the preferred embodiments of this invention have been described in detail, it will be understood that various modifications may be made therein, and it is intended to cover in the appended claims all such modifications as fall within the true spirit and scope of this invention.

What is claimed is:

1. An image encoding apparatus comprising:
a conversion table for recording therein a rearrangement rule for an encoded data where the encoded data is divided into a plurality of data and a restart marker is intervened between the adjacent divided data;
an encoder for generating the encoded data by encoding image data based on JPEG method using the restart marker; and
a scramble converter for dividing the encoded data outputted from the encoder into the plurality of data with the restart marker and rearranging the divided data based on the rearrangement rule recorded in the conversion table.

2. The image encoding apparatus as claimed in claim 1, wherein the encoder encodes the image data using the restart marker per n X macro block (n is a natural number).

3. The image encoding apparatus as claimed in claim 1, wherein the restart marker is set to be made cycling every predetermined number, and the conversion table records therein a rule for rearranging the data put together by a pair of restart markers located at adjacent order to each other in cycle of an arbitrary restart marker and the data put together by a pair of restart markers located at the same order as that of the pair of restart markers in cycle of another restart marker as the rearrangement rule.

4. The image encoding apparatus according to claim 1, wherein the restart marker is set to be made cycling every predetermined number, and the conversion table records therein a rule for rearranging all of the data included in cycle of an arbitrary restart marker and all of the data included in cycle of another restart marker as the rearrangement rule.

5. The image encoding apparatus according to claim 1, wherein the restart marker is set to be made cycling every predetermined number, and the conversion table records therein a rule for randomly rearranging each of the data put together by a pair of restart markers located at adjacent order to each other in cycle of an arbitrary restart marker and each of the data put together by a pair of restart markers located at adjacent order to each other in cycle of another restart marker as the rearrangement rule.

6. The image encoding apparatus according to claim 1, wherein the conversion table records a plurality of rearrangement rules therein, further comprising:
an input unit for accepting an input operation of an operator who designates a particular rule among the plurality of rearrangement rules in the conversion table; and
a display unit for displaying an image assisting the selection from the plurality of rearrangement rules.

7. The image encoding apparatus according to claim 1, wherein the conversion table records therein a rule for alternately rearranging the data in a plurality of encoded data as the rearrangement rule.

8. The image encoding apparatus according to claim 1, wherein the conversion table records therein a rule for rearranging the data constituting a part of the encoded data as the rearrangement rule.

9. The image encoding apparatus according to claim 1, further comprising a central unit for inserting the rearrangement rule into at least one of an APP1 marker segment and an APP2 marker segment of the encoded data.

10. The image encoding apparatus according to claim 1, wherein the scramble converter -rewrites the restart markers failing to follow predetermined correct order due to the rearrangement rule so as to follow the correct order.

11. An image decoding apparatus comprising:
a conversion table for recording therein a rearrangement rule for the encoded data where the encoded data is divided into a plurality of data and a restart marker is intervened between the adjacent divided data;
a scramble converter for dividing the encoded data into the plurality of data using the restart marker and rearranging the divided data based on the rearrangement rule recorded in the conversion table; and
a decoder for decoding the encoded data in which the data is rearranged by the scramble converter into image data based on JPEG method using the restart marker.

12. The image decoding apparatus according to claim 11, wherein
the restart marker is set to be made cycling every predetermined number, and the conversion table records therein a rule for rearranging the data put together by a pair of restart markers located at adjacent order to each other in cycle of an arbitrary restart marker and the data put together by a pair of restart markers located at the same order as that of the pair of restart markers in cycle of another restart marker as the rearrangement rule.

13. The image decoding apparatus according to claim 11, wherein
the restart marker is set to be made cycling every predetermined number, and the conversion table records therein a rule for rearranging all of the data included in cycle of an arbitrary restart marker and all of the data included in cycle of another restart marker as the rearrangement rule.

14. The image decoding apparatus according to claim 11, wherein
the restart marker is set to be made cycling every predetermined number, and the conversion table records therein a rule for randomly rearranging each of the data put together by a pair of restart markers located at adjacent order to each other in cycle of an arbitrary restart marker and each of the data put together by a pair of restart markers located at adjacent order to each other in cycle of another restart marker as the rearrangement rule.

15. The image decoding apparatus according to claim 11, wherein the conversion table records therein a plurality of rearrangement rules, and further comprising:
an input unit for accepting an input operation of an operator who designates a particular rule among the plurality of rearrangement rules in the conversion table; and
a display unit for displaying an image assisting the selection from the plurality of rearrangement rules.

16. The image decoding apparatus according to claim 11, wherein
the conversion table records therein a rule for alternately rearranging the data in a plurality of encoded data as the rearrangement rule.

17. The image decoding apparatus according to claim 11, further comprising a central unit for obtaining the rearrangement rule from at least one of an APP1 marker segment and an APP2 marker segment of the encoded data and recording the obtained rearrangement rule in the conversion table.

18. The image decoding apparatus according to claim 11, wherein
the scramble converter rewrites the restart markers failing to follow predetermined correct order due to the rearrangement rule so as to follow the correct order.

19. An image encoding method comprising:
an encoding step in which image data is encoded by means of a restart marker based on the JPEG method so that encoded data is generated; and
a scramble conversion step in which the encoded data is divided into a plurality of data by means of the restart marker and the divided data is rearranged based on a predetermined rearrangement rule.

20. The image encoding method according to claim 19, further including a macro block number setting step in which number of macro blocks sandwiched by the adjacent restart markers is set in the encoded data, wherein
the image data is encoded per n x macro block (n is a natural number) sandwiched by the restart markers in the encoding step.

21. The image encoding method according to claim 19, wherein the restart marker is set to be made cycling every predetermined number, and rearrangement is carried out between the data put together by a pair of restart markers located at adjacent order to each other in cycle of an arbitrary restart marker and the data put together by a pair of restart markers located at the same order as that of the pair of restart markers in cycle of another restart marker in the scramble conversion step.

22. The image encoding method according to claim 19, wherein the restart marker is set to be made cycling every predetermined number, and rearrangement is carried out between all of the data included in cycle of an arbitrary restart marker and all of the data included in cycle of another restart marker in the scramble conversion step.

23. The image encoding method according to claim 19, wherein the restart marker is set to be made cycling every predetermined number, and random rearrangement is carried out between each of the data put together by a pair of restart markers located at adjacent order to each other in cycle of an arbitrary restart marker and each of the data put together by a pair of restart markers located at adjacent order to each other in cycle of another restart marker in the scramble conversion step.

24. The image encoding method according to claim 19, further including a designating step and a display step, wherein
an arbitrary rearrangement rule is designated from a plurality of rearrangement rules in the designating step, and
the data is rearranged based on the arbitrary rearrangement rule designated in the designating step in the scramble conversion step, and
an image assisting the selection from the plurality of rearrangement rules is displayed in the display step.

25. The image encoding method according to claim 19, wherein the data is alternately rearranged in a plurality of encoded data in the scramble conversion step.

26. The image encoding method according to claim 19, further including a header insertion step in which the rearrangement rule is inserted into at least one of an APP1 marker segment and an APP2 marker segment of the encoded data.

27. The image encoding method according to claim 19, wherein the restart markers failing to follow predetermined correct order due to the rearrangement rule are rewritten so as to follow the correct order in the scramble conversion step.

28. An image decoding method comprising:
a scramble conversion step in which encoded data is divided into a plurality of data using a restart marker and the divided data is rearranged based on a predetermined rearrangement rule; and
a decoding step in which the encoded data is decoded into image data based on JPEG method using the restart marker.

29. The image decoding method according to claim 28, wherein the restart marker is set to be made cycling every predetermined number, and rearrangement is carried out between the data put together by a pair of restart markers located at adjacent order to each other in cycle of an arbitrary restart marker and the data put together by a pair of restart markers located at the same order as that of the pair of restart markers in cycle of another restart marker in the scramble conversion step.

30. The image decoding method according to claim 28, wherein
the restart marker is set to be made cycling every predetermined number, and rearrangement is carried out between all of the data included in cycle of an arbitrary restart marker and all of the data included in cycle of another restart marker in the scramble conversion step.

31. The image decoding method according to claim 28, wherein
the restart marker is set to be made cycling every predetermined number, and random rearrangement is carried out between each of the data put together by a pair of restart markers located at adjacent order to each other in cycle of an arbitrary restart marker and each of the data put together by a pair of restart markers adjacent to each other in cycle of another restart marker in the scramble conversion step.

32. The image decoding method according to claim 28, further including a designating step and a display step, wherein
an arbitrary rearrangement rule is designated from a plurality of rearrangement rules in the designating step, and
the data is rearranged based on the arbitrary rearrangement rule designated in the designating step in the scramble conversion step, and
an image assisting the selection from the plurality of rearrangement rules is displayed in the display step.

33. The image decoding method according to claim 28, wherein
the data is alternately rearranged in a plurality of encoded data in the scramble conversion step.

34. The image decoding method according to claim 28, further including a header-obtaining step in which the rearrangement rule is obtained from at least one of an APP1 marker segment and an APP2 marker segment of the encoded data.

35. The image decoding method according to claim 28, wherein
the restart markers failing to follow predetermined correct order due to the rearrangement rule are rewritten so as to follow the correct order in the scramble conversion step.
